(19) United States
(12) Patent Application Publication
(10) Pub. No.: US 2005/0135378 A1
(43) Pub. Date: Jun. 23, 2005

(54) Service aware policer with efficient handling of in-profile traffic

(75) Inventors: Sameh Rabie, Kanata (CA); Osama Aboul Magd, Kanata (CA)

Correspondence Address: SMART AND BIGGAR, 438 UNIVERSITY AVENUE, SUITE 1500 BOX 111, TORONTO, ON, M5G2K8, CA

(73) Assignee: Nortel Networks Limited

(21) Appl. No.: 10/740,408

(22) Filed: Dec. 22, 2003

(51) Int. Cl. H04L 12/56

(52) U.S. Cl. 370/395.21; 370/235

(57) ABSTRACT

A service aware policer considers conformance to committed parameters before considering conformance to excess parameters. Such a flexible policer, which may be considered to be concerned with two rates and three colors, may find application in IP DiffServ, Metro Ethernet, etc. In particular, the policer, given a service associated with a given received packet, uses a profile specific to the associated service, where the profile provides values for the two rates. Subsequently, a token bucket rate algorithm allows the policer to transmit the given received packet for marking with one of the three colors. The policer may operate in a Color Blind mode in which the one of three colors (green, yellow, red) already associated with a packet is not considered or a Color Aware mode in which the color already associated with a packet is considered together with the size of the packet. Advantageously, the parameters may be defined in such a way that the efficiency of handling in-profile traffic is improved for predominant service scenarios over a wide range of traffic parameters.

### FIELD OF THE INVENTION

The present invention relates to policing in data communications networks and, in particular, to service aware policing that incorporates efficient handling of in-profile traffic.

### BACKGROUND

A provider of data communications services typically provides a customer access to a large data communication network. This access is provided at a “provider edge” switch/router that connects a “customer edge” device in a customer network to the large data communication network. Due to service providers having a broad range of customers with a broad range of needs, the service providers prefer to charge for their services in a manner consistent with a level of performance assurance. Such an arrangement also benefits the customer. To this end, a Service Level Specification (SLS) is typically negotiated between customer and service provider.

An SLS is, generally, a contract between a network service provider and a customer that specifies, usually in measurable terms, one or more levels of performance assurance that the network service provider will furnish. These levels of performance assurance, which may be called Quality of Service (QoS) levels or, more simply, “service classes”, may include, for instance, premium, gold and standard. The network service provider generally expects the customers to use the network in a manner consistent with a bandwidth profile described in the SLS. The bandwidth profile associated with a given customer specifies the volume of the traffic expected from the given customer over a specified period of time. Rather than rely on the customer to only utilize the provided network resources to level contracted, i.e., to stay “in-profile”, service providers often rely on “policing”.

Policing involves the inspection of traffic and then the taking of an action based on various characteristics of that traffic. These characteristics may be, for instance, based on whether the traffic is over or under a given rate or based on an indication in the header of the protocol data units (e.g., packets) of the traffic. Such an indication may include a Differentiated Services Code Point (DSCP, see Blake, S., et. al., “An Architecture for Differentiated Services”, Internet Engineering Task Force (IETF) Request for Comments (RFC) 2475, December 1998, which may be found at www.ietf.org) or an “IP Precedence”.

The Differentiated Services framework and the six-bit DSCP field associated with the framework were created as successors to IP Precedence, a scheme whereby network operators could use three bits in a “Type of Service” (ToS) byte in an IP header to prioritize traffic. IP Precedence enabled the creation of eight service classes, compared with the 64 classes now possible using the Differentiated Services framework.

A “policer” (that which implements policing) may be implemented in software, firmware, hardware, individually or in combination.

A performance assurance system, including a policer, generally receives packets of incoming traffic for transmission or rejection. Additionally, for a packet selected for transmission, the performance assurance system may modify some aspect of the packet of traffic, such as one or more of the qualities of the packet, as identified by bits in the header of the packet.

Historically, service providers could furnish a customer with a dedicated point-to-point connection to, for instance, connect a branch office to a main office. However, service providers have been evolving to offer leased line connections over shared network infrastructure. That is, a dedicated connection (over an access line that may carry many such connections) is used from one end point of the leased line (the customer network) to the service provider edge router, but the service provider uses a shared network to connect to the other end point of the leased line. This is often accomplished using Layer 2 technologies like Frame Relay (FR) and Asynchronous Transfer Mode (ATM). “Layer 2” is the Data Link layer of the commonly-referenced multi-layered communication model, Open Systems Interconnection (OSI).

In FR and ATM networks, the connection from customer equipment to provider edge is typically arranged to support a single class of service. However, emerging networks provide connections from customer equipment to provider edge that support multiple classes of service. For example, a single virtual private network (VPN) connection from customer equipment to provider edge may be arranged to support premium, gold and standard classes of service. The premium, gold and standard classes of service may be defined in terms of, for instance, guaranteed minimum bandwidth, maximum packet loss, maximum delay (latency) and maximum jitter.

Policing on a single connection provided by FR and ATM networks need not be explicitly aware of the service class of the traffic, as connections of this type typically only carry traffic of a single service class. However, where policing is required for a single connection capable of carrying traffic of multiple service classes, such as provided by one of the emerging networks, a policer may be required that can police traffic according to a profile associated with a service class determined for that traffic.

A policing algorithm that is of use in service aware policers has been described in J. Heinanen, R. Guerin, IETF RFC 2698, titled “A Two Rate Three Color Marker” (see www.ietf.org). RFC 2698 describes a “Two Rate Three Color Marker” (trTCM) that can be used as a component in a Differentiated Services (“DiffServ”) traffic conditioner. The trTCM meters an Internet Protocol (IP) packet stream and marks packets of the IP packet stream based on two rates, Peak Information Rate (PIR) and Committed Information Rate (CIR), and burst sizes associated with each rate, i.e., peak burst size (PBS) and committed burst size (CBS). The packets may be marked either green, yellow or red. A given packet may be marked red if transmission of the given packet would require the policer to exceed the PIR. Otherwise the packet may either be marked yellow, if transmission of the given packet would require the policer to exceed the CIR, or marked green, if transmission of the given packet would not require the policer to exceed the CIR.

Unfortunately, the algorithm described RFC 2698 has been found to be inefficient in handling in-profile traffic. Additionally, when the value for the PBS is smaller than the value for the CBS for the marker defined in RFC 2698, the customer equipment may be required to shape traffic to a certain PIR.

### SUMMARY

A service aware policer that considers conformance to committed parameters before considering conformance to peak, or excess, parameters may be found to handle in-profile traffic more efficiently than known policers. Advantageously, parameters may be defined in such a way that the efficiency of handling in-profile traffic is improved for predominant service scenarios over a wide range of traffic parameters. Furthermore the need for customer edge devices to shape traffic to a certain peak information rate may be obviated.

In a Color Aware mode of operation, the service aware policer provides an advantage over the color aware operation of the policer described in RFC 2698 in that a committed token count is not depleted by yellow packets.

In accordance with an aspect of the present invention there is provided a method of policing a protocol data unit. The method, which may be understood to correspond to a Color Blind mode of operation, includes retrieving a committed token count and an excess token count based on a service level associated with the protocol data unit. The method further includes, if the committed token count is positive, decreasing the committed token count by the size of the protocol data unit and, if the committed token count is not positive, but the excess token count is positive, decreasing the excess token count by the size of the protocol data unit. The method also includes processing the protocol data unit based on whether the committed token count is positive and whether the excess token count is positive. Additionally, a policer for policing protocol data units by way of this method is also provided.

In accordance with another aspect of the present invention there is provided a method of policing a protocol data unit. The method, which may be understood to correspond to a Color Aware mode of operation, includes retrieving a committed token count and an excess token count based on a service level associated with the protocol data unit and receiving an indication of a color to associate with the protocol data unit, the color capable of being green, yellow or red. The method further includes, if the color is green and the committed token count is positive, decreasing the first size measure by the size of the protocol data unit and, if the color is yellow or the committed token count is not positive but the excess token count is positive, decreasing the second size measure by the size of the protocol data unit. The method also includes processing the protocol data unit based on the color, whether the committed token count is positive and whether the excess token count is positive. Additionally, a policer for policing protocol data units by way of this method is also provided.

In accordance with a further aspect of the present invention there is provided a method of policing a protocol data unit. The method, which may be understood to correspond to a Color Blind mode of operation, includes retrieving a first dynamic size measure and a second dynamic size measure based on a service level associated with the protocol data unit. The method further includes, if the first dynamic size measure is positive, decreasing the first size measure by the size of the protocol data unit and, if the first dynamic size measure is not positive, but the second dynamic size measure is positive, decreasing the second size measure by the size of the protocol data unit. The method also includes processing the protocol data unit based on whether the first dynamic size measure is positive and whether the second dynamic size measure is positive. Additionally, a policer for policing protocol data units by way of this method is also provided, along with a computer readable medium for allowing a processor in a router to perform the method.

In accordance with a still further aspect of the present invention there is provided a method of policing a protocol data unit. The method, which may be understood to correspond to a Color Aware mode of operation, includes retrieving a first dynamic size measure and a second dynamic size measure based on a service level associated with the protocol data unit and receiving an indication of a value of a distinguishing parameter to associate with the protocol data unit, the distinguishing parameter capable of taking a first value, a second value or a third value. The method further includes, if the value of the distinguishing parameter is the first value and the first dynamic size measure is positive, decreasing the first size measure by the size of the protocol data unit and, if the value of the distinguishing parameter is the second value or the first dynamic size measure is not positive and the second dynamic size measure is positive, decreasing the second size measure by the size of the protocol data unit. The method also includes processing the protocol data unit based on the value of distinguishing parameter, whether the first dynamic size measure is positive and whether the second dynamic size measure is positive. Additionally, a policer for policing protocol data units by way of this method is also provided, along with a computer readable medium for allowing a processor in a router to perform the method.

In accordance with an even further aspect of the present invention there is provided a performance assurance system. The performance assurance system includes a traffic classifier, a marker and a policer. The policer is adapted to receive a protocol data unit from the traffic classifier, receive a service level associated with the protocol data unit from the traffic classifier and retrieve a first dynamic size measure and a second dynamic size measure based on the service level associated with the protocol data unit. The policer is further adapted to decrease the first size measure by the size of the protocol data unit if the first dynamic size measure is positive, decrease the second size measure by the size of the protocol data unit if the first dynamic size measure is not positive, but the second dynamic size measure is positive and transmit the protocol data unit to the marker based on whether the first dynamic size measure is positive and whether the second dynamic size measure is positive.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures which illustrate example embodiments of this invention:

FIG. 1 illustrates a data communication network suitable for implementation of the present invention;

FIG. 2 illustrates a functional block diagram of a performance assurance system including a policer, according to an embodiment of the present invention;

FIG. 3 illustrates steps of a policing method according to an embodiment of the present invention;

FIG. 4 illustrates steps of a Color Blind metering step of the policing method of FIG. 3; and

FIG. 5 illustrates steps of a Color Aware metering step of the policing method of FIG. 3.

### DETAILED DESCRIPTION

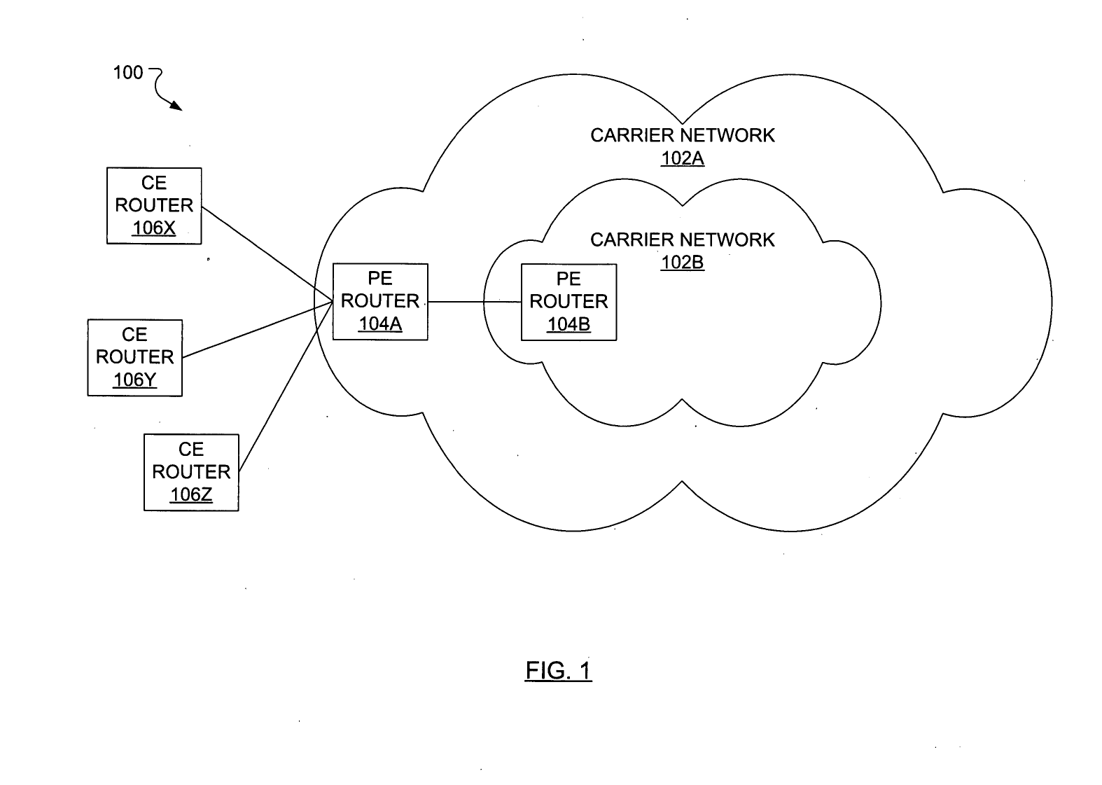

FIG. 1 illustrates elements of a number of data communication networks. In particular, a first provider edge (PE) router 104 is an element of a first carrier network 102A and allows access thereto. More particularly, the first PE router 104A allows several customer edge (CE) routers 106X, 106Y, 106Z access to the first carrier network 102A. Within the first carrier network 102A is a second carrier network 102B to which access, by the first PE router 104A, may be granted by a second PE router 104B.

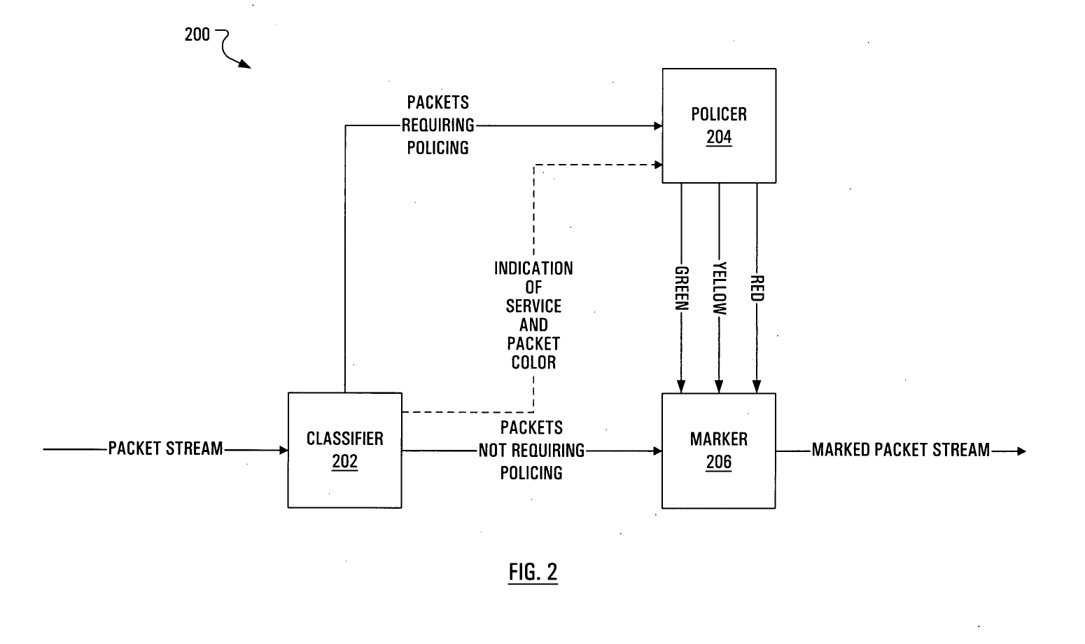

FIG. 2 illustrates a performance assurance system 200 that may form a portion of one or both of the PE routers 104A, 104B. The performance assurance system 200 includes a packet classifier 202 that may determine the service of a particular received packet, the color of the received packet and whether the determined service requires policing. Where the determined service requires policing, the packet classifier 202 forwards the particular received packet to a policer 204. Where the determined service does not require policing, the packet classifier 202 forwards the particular received packet to a marker 206. Under the conditions in which the packet classifier 202 forwards the particular received packet to the policer 204, the packet classifier 202 may indicate to the policer 204 the determined service associated with the particular received packet. In some instances, the packet classifier may also indicate to the policer 204 a color to associate with the particular received packet. The policer 204, after processing a received packet, may transmit the received packet to the marker 206 for marking and forwarding, or may discard the packet outright. As illustrated in FIG. 2, the manner in which the received packet is transmitted to the marker 206 may indicate to the marker 206 a color with which to mark the packet.

In overview, the packet classifier 202 determines the service class of a received packet (from connection identifier, subscription option, or from information from the OSI Layer 1-7 header of the packet) and further determines whether the determined service class requires policing. If the service class is determined to be among those service classes that require policing, the packet classifier 202 may transmit the packet and an indication of the service class to the policer 204. Depending on the mode of operation of the policer 204 (to be discussed hereinafter), the packet classifier 202 may also transmit and indication of the color of the received packet to the policer 204. The policer 204 may be seen to operate according to an algorithm that may be characterized by a profile. The profile may, for instance, include four parameters, namely: committed information rate (CIR); committed burst size (CBS); excess information rate (EIR); and excess burst size (EBS). Packets that conform to the CIR and the CBS may be called in-profile packets. Other packets may be called out-of-profile packets. In-profile packets are transmitted to the marker 206 for appropriate marking and forwarding. Depending on the profile, some, if not all, out-of-profile packets are also transmitted to the marker 206.

In general, the CIR and EIR values are set independently. However, in an alternative case, the CIR and EIR values can be correlated to the CBS and EBS values, respectively, by the introduction of a burst duration parameter, “T”, where T=CBS/CIR=EBS/EIR. In the latter case, only three parameters are required to define a profile.

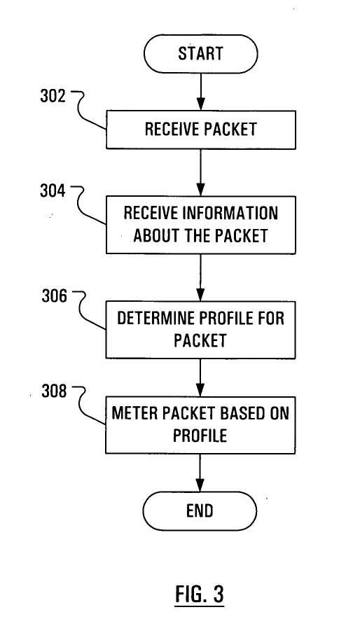

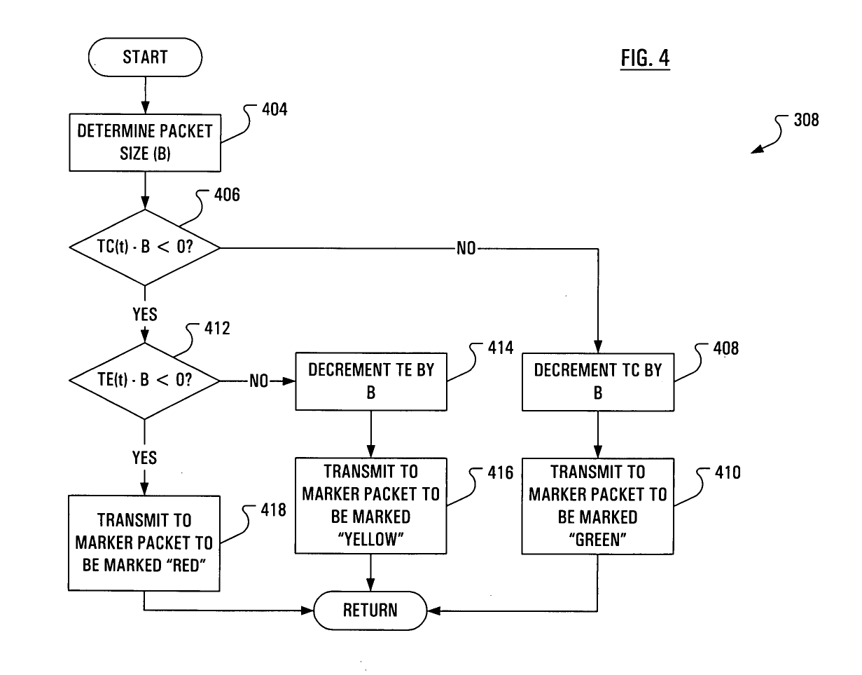

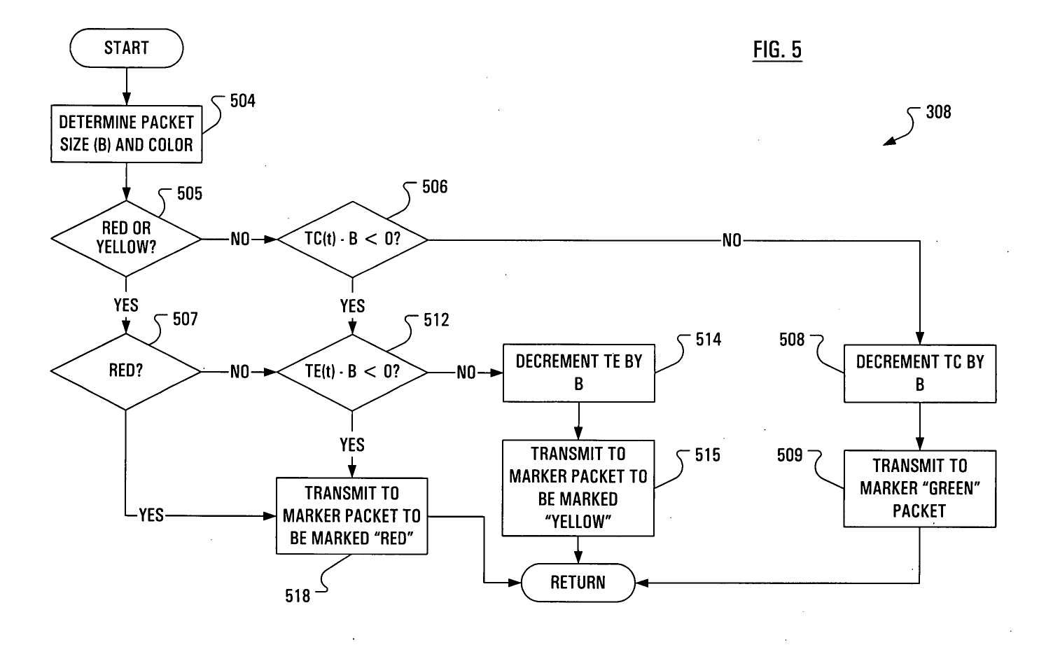

With reference to FIG. 3 along with FIG. 2, in operation, the policer 204 receives a packet (step 302). Information about the packet may then be received from the packet classifier 202 (step 304). Such information may include an indication of a service to associate with the packet and a color to associate with the packet. Given the service associated with the packet, a profile to use for metering the packet is then determined (step 306). Using the determined profile, the packet may then be metered (step 308). The metering of the packet may be performed in Color Blind mode or Color Aware mode as will be described in detail hereinafter in conjunction with descriptions of FIGS. 4 and 5.

In the Color Blind mode, the policer 204 assumes that packets in the packet stream are uncolored, that is, no color information is received from the packet classifier 202. In the Color Aware mode the policer 204 assumes that some preceding entity has pre-colored the incoming packet stream so that each packet includes one of three color indications: green; yellow; or red.

The marking of a packet with a color (steps 410, 416, 418) may involve placing a code in a “DS field” described in Nichols, K., et al., “Definition of the Differentiated Services Field (DS Field) in the IPv4 and IPv6 Headers”, IETF RFC 2474, December 1998 (see www.ietf.org). Such marking of the packet may be performed in a per-hop behavior (PHB) specific manner. In case of the Assured Forwarding Per-Hop Behavior (PHB) group described in Heinanen, J., et al., “Assured Forwarding PHB Group”, IETF RFC 2597, June 1999 (see www.ietf.org), the color can be coded as the drop precedence of the packet. Other PHB groups may include expedited forwarding and default forwarding.

Policing methods exemplary of the present invention may be based upon token bucket rate algorithms. In such algorithms, token buckets are defined to have a capacity and a fill rate. Predefined actions by the meter employing a token bucket rate algorithm cause the number of tokens (a token count or, generically, a dynamic size measure) in a token bucket to be diminished. The missing tokens may then be replenished at the fill rate, where such replenishment is limited by the capacity of the token bucket.

Relative to the four aforementioned parameters, the committed burst size (CBS) may be used to define the capacity of a committed token bucket (TC) and the committed information rate (CIR) may be used to define the fill rate of the committed token bucket. Similarly, the excess burst size (EBS) may be used to define the capacity of an excess token bucket (TE) and excess information rate (EIR) may be used to define the fill rate of the excess token bucket.

The CBS and EBS may be expressed as a number of traffic units (e.g., bits, bytes) and should be configured to be greater than the expected maximum length of incoming protocol data units. It should be understood that, for some protocols, the length of incoming protocol data units may be fixed. Both CIR and EIR may be expressed in traffic units per second. The number of tokens, which may be representative of traffic units, in a token bucket may be updated periodically, perhaps with a period of P seconds. For implementation efficiency reasons, other methods may be used for updating the bucket, for example, the number of tokens in a token bucket may be updated on the receipt of a packet to be policed rather than relying on a time-based updating method. All updating methods must yield the same policing behavior. Clearly, the number of tokens in a token bucket should not exceed the capacity of the bucket.

For example, at a time t+, just after an update, the number of tokens in the committed token bucket TC may be determined as TC(t+)=min{CBS, TC(t−)+CIR*P}. The time t− may be considered the time just before the update. Similarly, at time t+, the number of tokens in the excess token bucket TE may be determined as TE(t+)=min{EBS, TE(t−)+EIR*P}.

The steps of the metering step (step 308, FIG. 3) in Color Blind mode are illustrated in FIG. 4. The received packet is first examined to determine the size (B) of the packet (step 404). Given the size of the packet, it is determined whether the size of the packet exceeds the number of tokens currently in the committed token bucket (step 406). That is, it is determined, at time t, whether TC(t)−B<0. If it is determined that the size of the packet does not exceed the number of tokens currently in the committed token bucket, the number of tokens in the committed token bucket is decremented by the size of the packet (step 408) and the packet may be transmitted to the marker 206 to be marked green (step 410).

If it is determined (step 406) that the size of the packet exceeds the number of tokens currently in the committed token bucket, it is then determined whether the size of the packet exceeds the number of tokens currently in the excess token bucket (step 412). That is, it is determined, at time t, whether TE(t)−B<0. If it is determined that the size of the packet does not exceed the number of tokens currently in the excess token bucket, the number of tokens in the excess token bucket is decremented by the size of the packet (step 414) and the packet may be transmitted to the marker 206 to be marked yellow (step 416).

If it is determined (step 412) that the size of the packet exceeds the number of tokens currently in the excess token bucket, the packet may be transmitted to the marker 206 to be marked red (step 418).

Notably, in some implementations, the packet may be accepted if there are any tokens left in the token bucket, irrespective of packet size. In such implementations, the user is allowed to borrow a number of tokens up to a maximum deficit that is one token fewer than the maximum packet size, in which case number of tokens in the token bucket becomes a negative integer. However, since the next packet may not be accepted until the token bucket is replenished to at least a positive state, the long-term traffic rate of the policer 204 remains unchanged.

Note that updating of the buckets every P seconds is independent of the metering steps so that it is possible for the committed token bucket and excess token bucket to be updated after the committed token bucket has been read during metering but before the excess token bucket has been read.

Although the Color Blind mode is universally useful, there are scenarios wherein packets have been previously colored in which the Color Aware mode is particularly useful. Where policing is implemented at a User-Network Interface (UNI), for instance, in FIG. 1 at the first PE router 104A which connects to the CE routers 106X, 106Y, 106Z, the Color Aware mode may be seen as useful when the packets are generated by applications that generate colored packets, e.g., video applications. Where policing is implemented at a Network-Network Interface (NNI),for instance, in FIG. 1 at the second PE router 104B which connects to the first PE router 104A, the Color Aware mode may be seen as useful when the networks have an SLS in place.

The steps of the metering step (step 308, FIG. 3) in Color Aware mode are illustrated in FIG. 5. Initially, the size (B) and the color of the received packet (step 504) are determined. Such packet specific information (size, color) may be received from the classifier. Notably, the packet classifier 202 may use any one of a wide variety of methods (e.g., methods based on OSI Layer 1-7 header, connection-ID, Policy, Configuration, etc.) to determine packet color (Green, Yellow, Red). Given the color of the packet, it is determined whether the packet is green (step 505). If it is determined that the packet is green, it is determined whether the size of the packet exceeds the number of tokens currently in the committed token bucket (step 506). That is, it is determined, at time t, whether TC(t)−B<0. If it is determined that the size of the packet does not exceed the number of tokens currently in the committed token bucket, the number of tokens in the committed token bucket is decremented by the size of the packet (step 508) and the packet may be transmitted to the marker (step 509).

If it is determined (step 506) that the size of the packet previously marked green exceeds the number of tokens currently in the committed token bucket or, subsequent to a determination that the packet is not marked green (step 505), if it is determined that the packet is marked yellow (step 507), it is then determined whether the size of the packet exceeds the number of tokens currently in the excess token bucket (step 512). That is, it is determined, at time t, whether TE(t)−B<0. If it is determined that the size of the packet does not exceed the number of tokens currently in the excess token bucket, the number of tokens in the excess token bucket is decremented by the size of the packet (step 514).

At this point, the packet is either a packet previously marked yellow (as determined in step 507) or a packet previously marked green (as determined in step 505) whose size exceeds the number of tokens currently in the committed token bucket (step 506). Without regard to the previous marking of the packet, the packet may be transmitted to the marker to be marked yellow (step 515).

If it is determined (step 512) that the size of the packet exceeds the number of tokens currently in the excess token bucket the packet may be transmitted to the marker to be marked red (step 518). The packet may also be transmitted to the marker to be marked red (step 518) subsequent to a determination that the packet is not yellow (step 507).

The Color Aware mode illustrated in FIG. 5 provides an advantage over the color aware operation of the policer described in RFC 2698 in that the committed token bucket (TC) is not depleted by yellow packets. If green and yellow packets arrive at a rate that exceeds the predetermined Peak Information Rate at a color aware RFC 2698 policer, the possibility exists that green packets will be rejected when too many preceding yellow packets have already been forwarded.

As will be appreciated by those skilled in the art, since the packet classifier 202 determines the color of a given packet, the disclosed policing algorithm may be applied independent of the protocol of the traffic stream. Furthermore, while the protocol data unit which is called a packet herein is also called a packet in the context of the Internet Protocol and Ethernet, the protocol data unit which is called a packet herein may be called a “cell” or a “frame” in protocols such as ATM and Frame Relay.

It should be clear that the described performance assurance system 200 may be used to mark packets associated with a service where different, decreasing levels of assurances (either absolute or relative) are given to packets which are marked as green, yellow, or red. For example, the performance assurance system 200 may discard all red packets, forward yellow packets with a “best effort” level of assurance and forward green packets with a “low drop probability” level of assurance. The performance assurance system 200 may be used for metering a multitude of services such as IP Virtual Private Network (VPN) services, OSI Layer 2 Virtual Private Networks, Metro Ethernet Services and MPLS, in both provider and enterprise networks.

Notably, the policer 204 may be found to be particularly useful in the IP DiffServ architecture. In that architecture, packets may be classified using any combination of the protocol layer information, such as layer 2 information (e.g., ATM connection, Ethernet interface/VLAN/MAC addresses, PPP, FR DLC, etc.), Layer 3 information (e.g., DSCP, IP source/destination addresses, protocol type), Layer 4 information (e.g., TCP/UDP port numbers) and other information from the upper layers (layers 5-7). The policer 204 may also be used in other important applications such as the emerging Layer 2 Metro Ethernet Services and in Ethernet-to-FR or Ethernet-to-ATM inter-working.

The IP DiffServ architecture may be used for an example of the operation of an aspect of the present invention, wherein a stream of packets of an assured forwarding service class may arrive at the performance assurance system 200. A DSCP in the IP header of each packet may represent of one of three traffic classes: AF31; AF32; and AF33.

Where the policer 204 is in the Color Blind mode of operation, the policer 204 receives each packet along with an indication that the service class of the packet is assured forwarding. According to the Color Blind mode of operation outlined in FIG. 4, the policer 204 first compares the size of a given received packet (in traffic units) to the number of tokens in the committed token bucket.

If the number of tokens in the committed token bucket exceeds the size of the given received packet, the number of tokens in the committed token bucket is decremented by the size of the given received packet and the given received packet is transmitted to the marker 206 for marking green. To mark the given received packet green, the marker 206 may insert a six bit DSCP in the header of the given received packet representative of the AF31 traffic class.

If the number of tokens in the committed token bucket is exceeded by the size of the given received packet, the size of the given received given received packet is compared to the number of tokens in the excess token bucket. If the number of tokens in the excess token bucket exceeds the size of the given received packet, the number of tokens in the excess token bucket is decremented by the size of the given received packet and the given received packet is transmitted to the marker 206 for marking yellow. To mark the given received packet yellow, the marker 206 may insert a six bit DSCP in the header of the given received packet representative of the AF32 traffic class.

If the number of tokens in the excess token bucket is exceeded by the size of the given received packet, the given received packet is transmitted to the marker 206 for marking red. To mark the given received packet red, the marker 206 may insert a six bit DSCP in the header of the given received packet representative of the AF33 traffic class.

Where the policer 204 is in the Color Aware mode of operation, the policer 204 receives each packet along with an indication that the service class of the packet is assured forwarding and an indication of the color of the given received packet. In particular, the packet classifier 202 indicates that a packet of the AF31 traffic class is green, a packet of the AF32 traffic class is yellow and a packet of the AF33 traffic class is red. According to the Color Aware mode of operation outlined in FIG. 5, the policer 204 first considers the color of the given received packet.

Where the given received packet is indicated to be green, the policer 204 compares the size of the green packet (in traffic units) to the number of tokens in the committed token bucket.

If the number of tokens in the committed token bucket exceeds the size of the green packet, the number of tokens in the committed token bucket is decremented by the size of the green packet and the green packet is transmitted to the marker 206 for marking green. Before marking a packet, the marker 206 may inspect the DSCP in the header of the packet and, where, as in this case, the DSCP is representative of the AF31 traffic class, the marker 206 may merely forward the green packet without performing marking.

If the number of tokens in the committed token bucket is exceeded by the size of the green packet, the size of the green packet is compared to the number of tokens in the excess token bucket. If the number of tokens in the excess token bucket exceeds the size of the green packet, the number of tokens in the excess token bucket is decremented by the size of the green packet and the green packet is transmitted to the marker 206 for marking yellow. Before marking a received packet, the marker 206 may inspect the DSCP in the header of the given received packet and, where, as in this case, the DSCP is representative of the AF31 traffic class, the marker 206 may change the DSCP to be representative of the AF32 traffic class.

If the number of tokens in the excess token bucket is exceeded by the size of the green packet, the green packet is transmitted to the marker 206 for marking red.

Before marking a received packet, the marker 206 may inspect the DSCP in the header of the given received packet and, where, as in this case, the DSCP is representative of the AF31 traffic class, the marker 206 may change the DSCP to be representative of the AF33 traffic class.

Where the given received packet is indicated to be yellow, the policer 204 compares the size of the yellow packet (in traffic units) to the number of tokens in the excess token bucket. If the number of tokens in the excess token bucket exceeds the size of the yellow packet, the number of tokens in the excess token bucket is decremented by the size of the yellow packet and the green packet is transmitted to the marker 206 for marking yellow. Before marking a packet, the marker 206 may inspect the DSCP in the header of the packet and, where, as in this case, the DSCP is representative of the AF32 traffic class, the marker 206 may merely forward the yellow packet without performing marking.

If the number of tokens in the excess token bucket is exceeded by the size of the yellow packet, the yellow packet is transmitted to the marker 206 for marking red. Before marking a packet, the marker 206 may inspect the DSCP in the header of the packet and, where, as in this case, the DSCP is representative of the AF32 traffic class, the marker 206 may change the DSCP to be representative of the AF33 traffic class.

Where the given received packet is indicated to be red, the policer 204 transmitted the yellow packet to the marker 206 for marking red. Before marking a packet, the marker 206 may inspect the DSCP in the header of the packet and, where, as in this case, the DSCP is representative of the AF33 traffic class, the marker 206 may merely forward the red packet without performing marking.

The indication from the packet classifier 202 to the policer 204 of the service class of a received packets allows for the support of multiple service classes simultaneously (e.g., Premium, Gold, Standard).

A Premium service class may be designed to provide lowest loss, lowest delay and lowest jitter and may correspond to the expedited forwarding service class. The profile associated with the Premium service class may specify a committed information rate (CIR) and specify that all out-of-profile traffic be dropped. When applied to the two token bucket policer 204 described hereinbefore, the profile may specify a zero excess burst size, a zero excess information rate (EIR) and that all red packets are to be dropped. Through the use of such a profile, the policer 204 supports a single guaranteed rate for packets of the Premium service class.

The Gold service class may correspond to the assured forwarding service class. The profile associated with the Gold service class may specify a minimum guaranteed bandwidth (CIR) and that an attempt should be made to deliver out-of-profile packets. An EIR may be also specified in the profile associated with the Gold service class as well as values for loss and delay. Through the use of such a profile, the policer 204 supports two rates, one each for guaranteed traffic and excess traffic, for packets of the Gold service class.

The Standard service class may correspond to the default forwarding service class. Although packets of the default forwarding service class are typically not policed, when packets of the default forwarding class are to be policed, the profile associated with the Standard service class may specify only an EIR. The loss, delay and jitter are typically not specified. When applied to the two token bucket policer 204 described hereinbefore, the profile may specify a zero committed information rate and a zero committed burst size. Through the use of such a profile, the policer 204 supports peak rate policing for packets of the Standard service class.

The use of DiffServ in the preceding examples reflects the fact that DiffServ is a common IP classification and marking scheme. It should be clear that the performance assurance system 200, and in particular the packet classifier 202, may use other fields or methods for classifying or grouping packets that are to be policed together. In addition to the classifications described hereinbefore, the packets may be classified according to Ethernet user priority (p-bits), a group of DSCPs, or a combination of multiple fields at different protocol layers, based on a Network Policy.

As will be apparent to a person skilled in the art, the implementation of the performance assurance system 200 generally, and the policer 204 specifically, in firmware, hardware or software individually or in combination. As such, the implementing PE router may require a processor (not shown).

Advantageously, the parameters (CIR, CBS, EIR, EBS) may be defined in such a way that the efficiency of handling in-profile traffic is improved for predominant service scenarios over a wide range of traffic parameters.

Further advantageously, the performance assurance system 200, including the policer 204 described herein, does not impose peak rate shaping requirements on customer edge devices.

Other modifications will be apparent to those skilled in the art and, therefore, the invention is defined in the claims.

1. A method of policing a protocol data unit, said method comprising:
retrieving a first dynamic size measure and a second dynamic size measure based on a service level associated with said protocol data unit;
if said first dynamic size measure is positive, decreasing said first size measure by said size of said protocol data unit;
if said first dynamic size measure is not positive, but said second dynamic size measure is positive, decreasing said second size measure by said size of said protocol data unit; and
processing said protocol data unit based on whether said first dynamic size measure is positive and whether said second dynamic size measure is positive.

2. The method of claim 1 further comprising increasing said first dynamic size measure at each expiry of a predefined period, said increasing limited by a maximum size.

3. The method of claim 2 wherein an amount of said increasing is equivalent to a product of said predefined period and a given information rate.

4. The method of claim 1 wherein said processing said protocol data unit comprises, where said first dynamic size measure is positive, transmitting said protocol data unit to be marked with a first indication.

5. The method of claim 1 wherein said processing said protocol data unit comprises, where said size of said protocol data unit does not exceed said first dynamic size measure, transmitting said protocol data unit to be marked with a first indication.

6. The method of claim 1 wherein said processing said protocol data unit comprises, where said first dynamic size measure is not positive and said second dynamic size measure is positive, transmitting said protocol data unit to be marked with a second indication.

7. The method of claim 1 wherein said processing said protocol data unit comprises, where said size of said protocol data unit exceeds said first dynamic size measure and does not exceed said second dynamic size measure, transmitting said protocol data unit to be marked with a second indication.

8. The method of claim 1 wherein said processing said protocol data unit comprises, where said first dynamic size measure is not positive and said second dynamic size measure is not positive, transmitting said protocol data unit to be marked with a third indication.

9. The method of claim 1 wherein said processing said protocol data unit comprises, where said size of said protocol data unit exceeds said first dynamic size measure and said second dynamic size measure, transmitting said protocol data unit to be marked with a third indication.

10. The method of claim 1 wherein said processing said protocol data unit comprises, where said size of said protocol data unit exceeds said second dynamic size measure, discarding said protocol data unit.

11. A policer for policing protocol data units, said policer adapted to:
retrieve a first dynamic size measure and a second dynamic size measure based on a service level associated with said protocol data unit;
decrease said first size measure by said size of said protocol data unit if said first dynamic size measure is positive;
decrease said second size measure by said size of said protocol data unit if said first dynamic size measure is not positive, but said second dynamic size measure is positive; and
process said protocol data unit based on whether said first dynamic size measure is positive and whether said second dynamic size measure is positive.

12. A policer for policing police protocol data units, said policer comprising:
means for retrieving a first dynamic size measure and a second dynamic size measure based on a service level associated with said protocol data unit;
means for decreasing said first size measure by said size of said protocol data unit if said first dynamic size measure is positive;
means for decreasing said second size measure by said size of said protocol data unit if said first dynamic size measure is not positive, but said second dynamic size measure is positive; and
means for processing said protocol data unit based on whether said first dynamic size measure is positive and whether said second dynamic size measure is positive.

13. A computer readable medium containing computer-executable instructions which, when performed by processor in a router, cause the processor to:
retrieve a first dynamic size measure and a second dynamic size measure based on a service level associated with a protocol data unit;
decrease said first size measure by said size of said protocol data unit if said first dynamic size measure is positive;
decrease said second size measure by said size of said protocol data unit if said first dynamic size measure is not positive, but said second dynamic size measure is positive; and
process said protocol data unit based on whether said first dynamic size measure is positive and whether said second dynamic size measure is positive.

14. A method of policing a protocol data unit, said method comprising:
retrieving a first dynamic size measure and a second dynamic size measure based on a service level associated with said protocol data unit;
receiving an indication of a value of a distinguishing parameter to associate with said protocol data unit, said distinguishing parameter capable of taking a first value, a second value or a third value;
if said value of said distinguishing parameter is said first value and said first dynamic size measure is positive, decreasing said first size measure by said size of said protocol data unit;
if said value of said distinguishing parameter is said second value or said first dynamic size measure is not positive and said second dynamic size measure is positive, decreasing said second size measure by said size of said protocol data unit; and
processing said protocol data unit based on said value of distinguishing parameter, whether said first dynamic size measure is positive and whether said second dynamic size measure is positive.

15. A policer for policing protocol data units, said policer adapted to:
retrieve a first dynamic size measure and a second dynamic size measure based on a service level associated with said protocol data unit;
receive an indication of a value of a distinguishing parameter to associate with said protocol data unit, said distinguishing parameter capable of taking a first value, a second value or a third value;
decrease said first size measure by said size of said protocol data unit if said value of said distinguishing parameter is said first value and said first dynamic size measure is positive;
decrease said second size measure by said size of said protocol data unit if said value of said distinguishing parameter is said second value or said first dynamic size measure is not positive and said second dynamic size measure is positive; and
process said protocol data unit based on said value of distinguishing parameter, whether said first dynamic size measure is positive and whether said second dynamic size measure is positive.

16. A policer for policing police protocol data units, said policer comprising:
means for retrieving a first dynamic size measure and a second dynamic size measure based on a service level associated with said protocol data unit;
means for receiving an indication of a value of a distinguishing parameter to associate with said protocol data unit, said distinguishing parameter capable of taking a first value, a second value or a third value;
means for decreasing said first size measure by said size of said protocol data unit if said value of said distinguishing parameter is said first value and said first dynamic size measure is positive;
means for decreasing said second size measure by said size of said protocol data unit if said value of said distinguishing parameter is said second value or said first dynamic size measure is not positive and said second dynamic size measure is positive; and
means for processing said protocol data unit based on said value of distinguishing parameter, whether said first dynamic size measure is positive and whether said second dynamic size measure is positive.

17. A computer readable medium containing computer-executable instructions which, when performed by processor in a router, cause the processor to:
retrieve a first dynamic size measure and a second dynamic size measure based on a service level associated with said protocol data unit;
receive an indication of a value of a distinguishing parameter to associate with said protocol data unit, said distinguishing parameter capable of taking a first value, a second value or a third value;
decrease said first size measure by said size of said protocol data unit if said value of said distinguishing parameter is said first value and said first dynamic size measure is positive;
decrease said second size measure by said size of said protocol data unit if said value of said distinguishing parameter is said second value or said first dynamic size measure is not positive and said second dynamic size measure is positive; and
process said protocol data unit based on said value of distinguishing parameter, whether said first dynamic size measure is positive and whether said second dynamic size measure is positive.

18. A method of policing a protocol data unit, said method comprising:
retrieving a committed token count and an excess token count based on a service level associated with said protocol data unit;
if said committed token count is positive, decreasing said committed token count by said size of said protocol data unit;
if said committed token count is not positive, but said excess token count is positive, decreasing said excess token count by said size of said protocol data unit; and
processing said protocol data unit based on whether said committed token count is positive and whether said excess token count is positive.

19. A policer for policing protocol data units, said policer adapted to:
retrieve a committed token count and an excess token count based on a service level associated with said protocol data unit;
decrease said committed token count by said size of said protocol data unit if said committed token count is positive;
decrease said excess token count by said size of said protocol data unit if said committed token count is not positive, but said excess token count is positive; and
process said protocol data unit based on whether said committed token count is positive and whether said excess token count is positive.

20. A policer for policing protocol data units, said policer comprising:
means for retrieving a committed token count and an excess token count based on a service level associated with said protocol data unit;
means for decreasing said committed token count by said size of said protocol data unit if said committed token count is positive;
means for decreasing said excess token count by said size of said protocol data unit if said committed token count is not positive, but said excess token count is positive; and
means for processing said protocol data unit based on whether said committed token count is positive and whether said excess token count is positive.

21. A method of policing a protocol data unit, said method comprising:
retrieving a committed token count and an excess token count based on a service level associated with said protocol data unit;
receiving an indication of a color to associate with said protocol data unit, said color capable of being green, yellow or red;
if said color is green and said committed token count is positive, decreasing said committed token count by said size of said protocol data unit;
if said color is yellow or said committed token count is not positive but said excess token count is positive, decreasing said excess token count by said size of said protocol data unit; and
processing said protocol data unit based on said color, whether said committed token count is positive and whether said excess token count is positive.

22. A policer for policing protocol data units, said policer adapted to:
retrieve a committed token count and an excess token count based on a service level associated with said protocol data unit;
receive an indication of a color to associate with said protocol data unit, said color capable of being green, yellow or red;
decrease said committed token count by said size of said protocol data unit if said color is green and said committed token count is positive;
decrease said excess token count by said size of said protocol data unit if said color is yellow or said committed token count is not positive but said excess token count is positive; and
process said protocol data unit based on said color, whether said committed token count is positive and whether said excess token count is positive.

23. A policer for policing protocol data units, said policer comprising:
means for retrieving a committed token count and an excess token count based on a service level associated with said protocol data unit;
means for receiving an indication of a color to associate with said protocol data unit, said color capable of being green, yellow or red;
means for decreasing said committed token count by said size of said protocol data unit if said color is green and said committed token count is positive;
means for decreasing said excess token count by said size of said protocol data unit if said color is yellow or said committed token count is not positive but said excess token count is positive; and
means for processing said protocol data unit based on said color, whether said committed token count is positive and whether said excess token count is positive.

24. A performance assurance system comprising:
a traffic classifier;
a marker;
a policer adapted to:
receive a protocol data unit from said traffic classifier;
receive a service level associated with said protocol data unit from said traffic classifier;
retrieve a first dynamic size measure and a second dynamic size measure based on said service level associated with said protocol data unit;
decrease said first size measure by said size of said protocol data unit if said first dynamic size measure is positive;
decrease said second size measure by said size of said protocol data unit if said first dynamic size measure is not positive, but said second dynamic size measure is positive; and
transmit said protocol data unit to said marker based on whether said first dynamic size measure is positive and whether said second dynamic size measure is positive.
